(19) United States
(12) Patent Application Publication
(10) Pub. No.: US 2018/0209192 A1
(43) Pub. Date: Jul. 26, 2018

(54) SLIDING DOOR

(71) Applicant: SELVAAG GRUPPEN AS, Oslo (NO)

(72) Inventor: Ole Gunnar Selvaag, Oslo (NO)

(21) Appl. No.: 15/744,020

(22) PCT Filed: Jul. 22, 2016
(86) PCT No.: PCT/NO2016/050163

§ 371 Date: Jan. 11, 2018

(30) Foreign Application Priority Data
Jul. 24, 2015 (NO) 20150964

(51) Int. Cl. E05D 15/06; E06B 3/46

(52) U.S. Cl. CPC E05D 15/0656; E05Y 2900/14; E05Y 2800/12; E06B 3/4654

(57) ABSTRACT

A sliding door arrangement comprising a sliding door (1) which is movably suspended in a rail system (23, 24) in order to be moved horizontally between two outer positions wherein it respectively opens and closes a door opening (10). The sliding door (11) is mounted in a cassette (1) arranged for insertion in a wall (15) in a building.

Sliding doors have the advantage that they are easy to operate for functionally disabled persons and the door function requires less space. Hinged doors swing out into the room and make them difficult to operate for people in wheelchairs. When the door is open, the space behind the door is often useless. The use of sill free sliding doors in dwellings instead of hinged doors has become all the more desirable because new building codes about accessibility and universal designs have become mandatory.

However, sliding doors have the weakness that they provide poor sound installation between rooms and seal poorly against draft and cold air. Furthermore, sliding doors are more complicated to install because the door leaf, rails, casters and floor guides are delivered as separate parts. The door leaf and rails can be mounted on the outside of the wall, the result being that the wall where the door runs cannot be furnished. Alternatively, the door leaf and rails can be mounted inside a double wall, making the wall thicker and more costly and requiring more room than a regular wall. In total, sliding door solutions are relatively expensive, and their use is therefore more limited than desirable. The layout of dwellings could be more compact and area efficient with more extensive use of sliding door solutions.

The present invention alleviates these deficiencies by allowing the sliding door to be delivered to the building site fully installed and adjusted in an enclosing cassette solution. This solution permits the complete sliding door element to be mounted directly into an ordinary wall portion, without requiring the installer to have the technical abilities for mounting together the sliding door parts. Thus, the assembly work is shifted from the building site to controlled conditions in a factory.

A solution having a steel cassette around the sliding door may be mounted on the building site, for later completion with surface finishing like plaster boards or the like.

Another solution may be based more on wooden materials, where the sliding door element is delivered with a cassette of fiber board, for example MDF-plates. In this case the element is almost a finished wall portion which is integrated into the adjacent walls.

From the factory, the sliding doors may also be provided with an electrically driven motor for simpler operation (plug-in solution).

The sliding door is made sound insulating by placing dense sound-proofing means in the periphery of the door. Such means may be dense brushes having elastic bristle which extend practically sound-proof between the door leaf, walls and floor. Alternatively, a felt having elastic extending fibers can be used. It may also be envisioned to use elastic weather stripping permitting the door to move without troublesome friction, or a combination of brush and weather stripping. In order to prevent that the door leaf, slides directly against the wall material on the opposite side of the sealing means, a soft material may be installed, for instance felt, which provides the door with a smooth and “frictionless” movement.

For further understanding of the invention, it will be described more closely with reference to the appended drawings, where

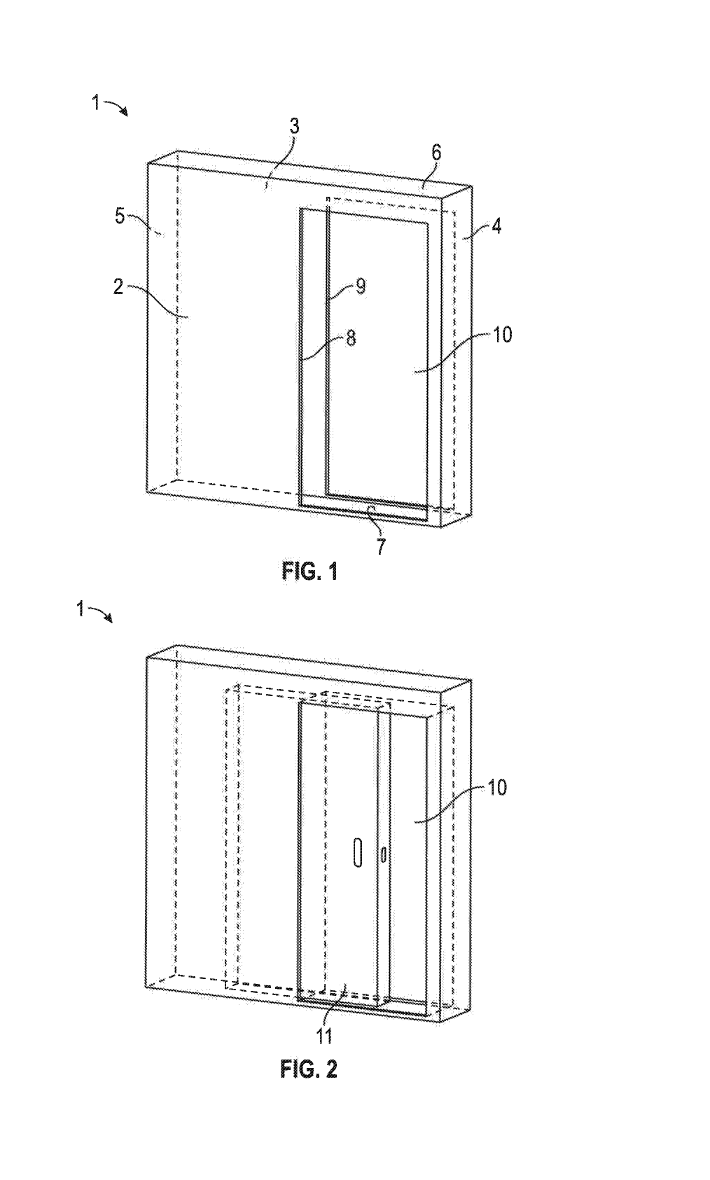

FIG. 1 is a perspective view of a sliding door cassette according to the invention,

FIG. 2 is a view similar to FIG. 1 and shows additionally an installed sliding door in semi-open position,

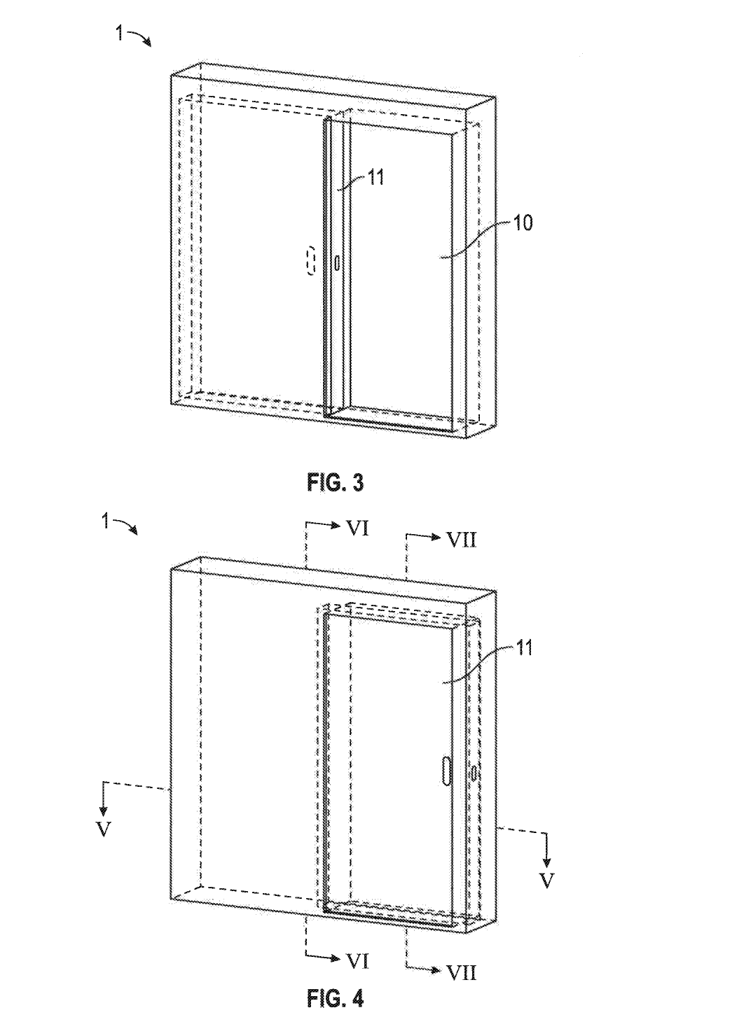

FIG. 3 shows a view similar to FIG. 2, but with the sliding door in open position,

FIG. 4 shows a view similar to FIG. 2, but with the sliding door in closed position,

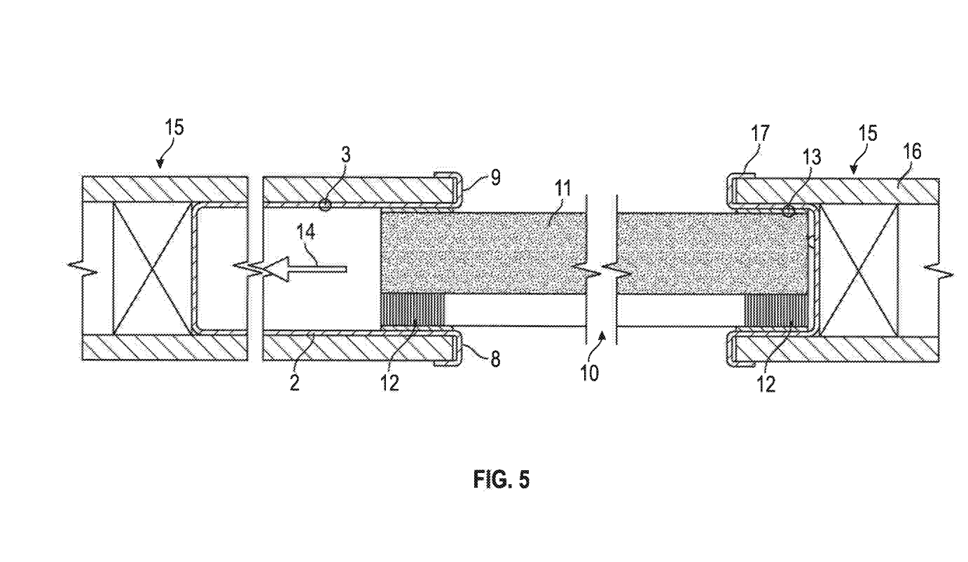

FIG. 5 shows a longitudinal section along the line V-V in FIG. 4,

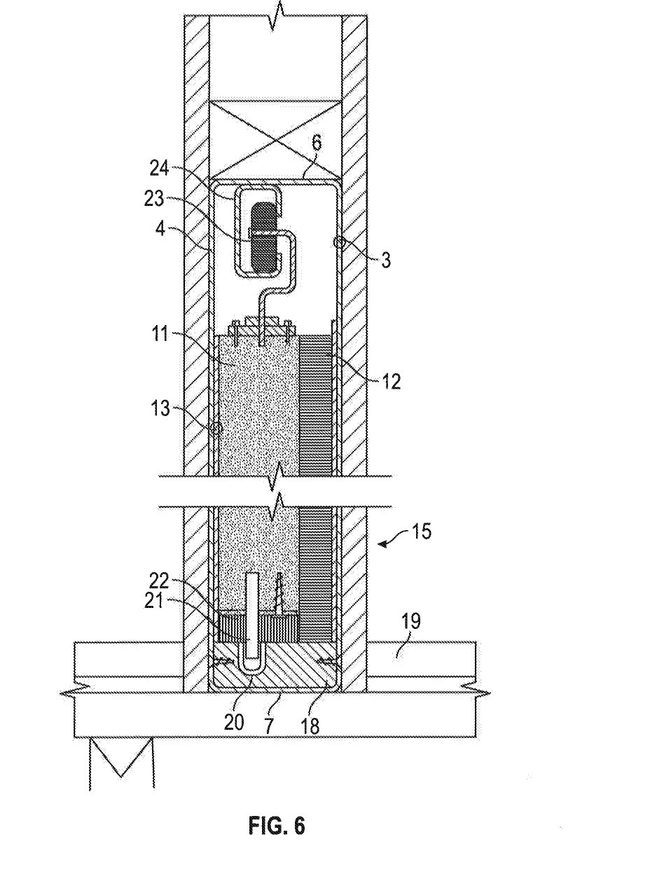

FIG. 6 shows a vertical section along the line VI-VI in FIG. 4,

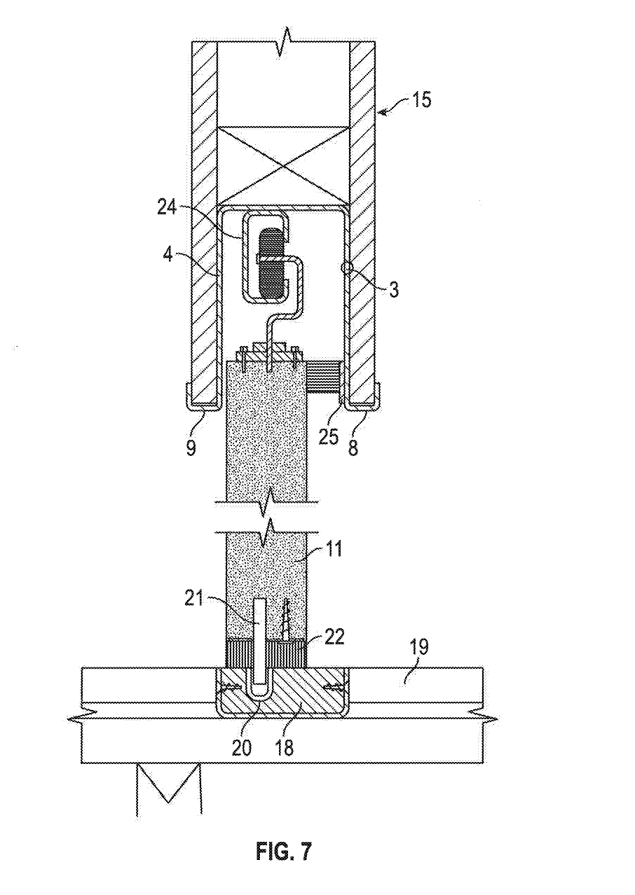

FIG. 7 shows a vertical section along the line VII-VII in FIG. 4,

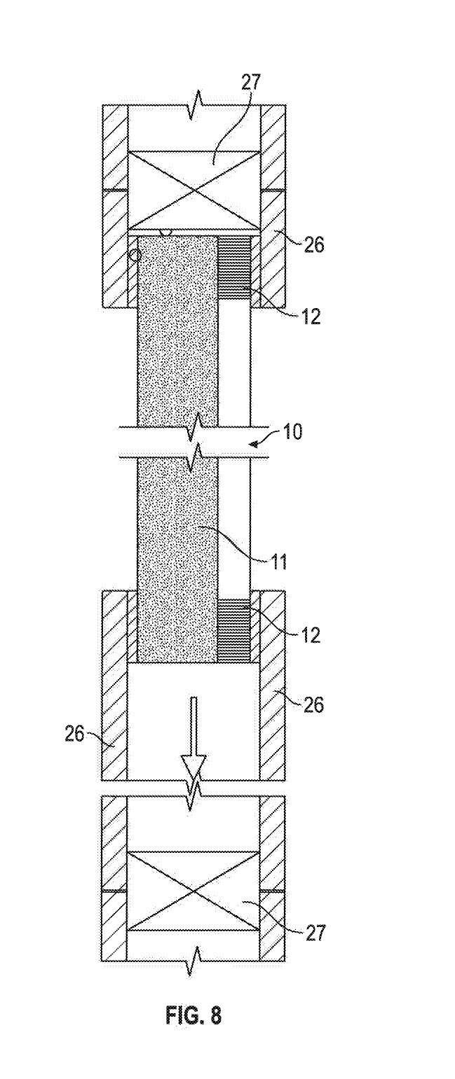

FIG. 8 shows a section similar to FIG. 5 through a second exemplifying embodiment of a sliding door cassette according to the invention,

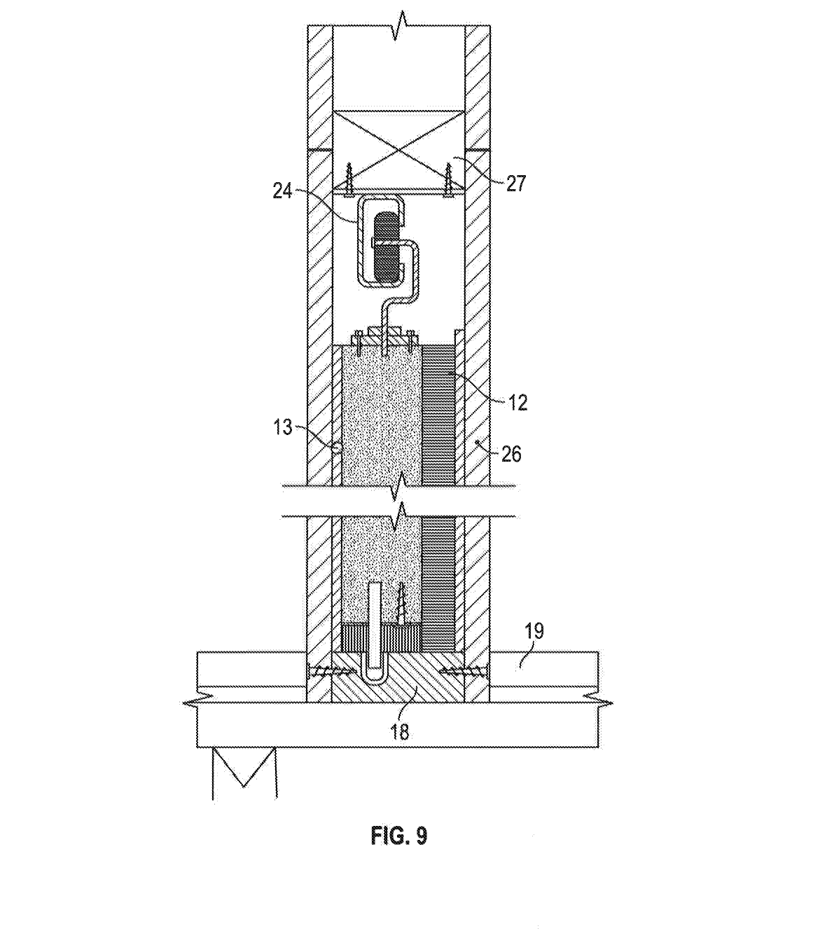

FIG. 9 is a section similar to FIG. 6 of this second exemplifying embodiment, and

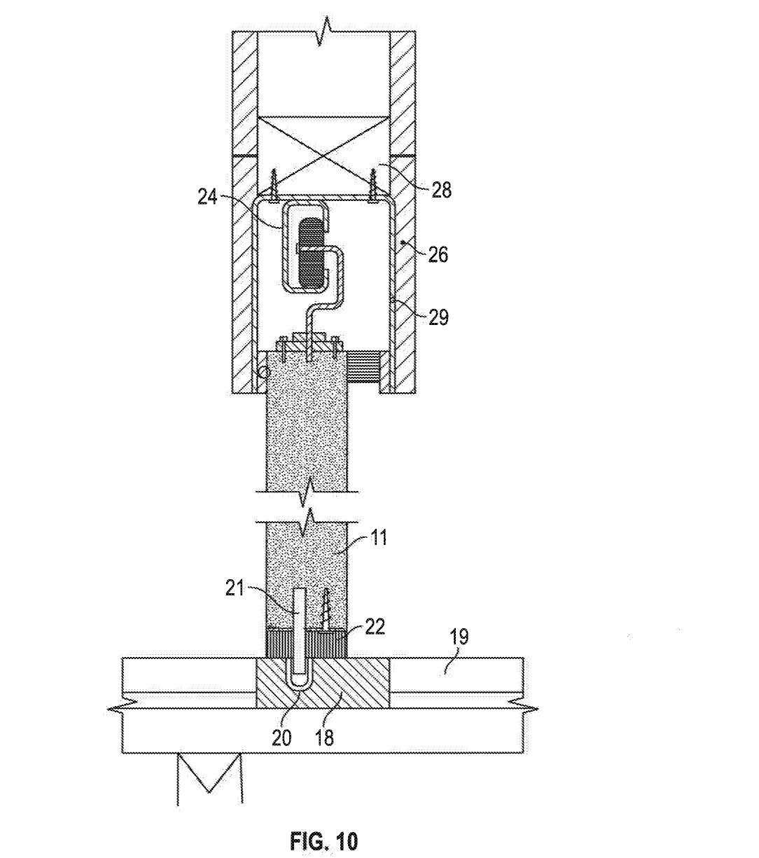

FIG. 10 is a section similar to FIG. 7 through a third exemplifying embodiment of the invention.

FIG. 1 schematically shows a sliding door cassette 1 according to the invention. The cassette is tall and narrow with substantially parallel epipedic form. It has two vertical long walls 2 and 3, two narrow vertical short walls 4 and 5, a top wall 6 and a bottom wall 7. The long walls 2, 3 are provided with opposite openings 8 and 9 in order to form a door opening 10.

FIG. 2 shows the sliding door cassette 1 in FIG. 1 with an installed sliding door 11 in semi-open position.

FIG. 3 shows like FIG. 2 the cassette 1 with a sliding door 11 installed, but with the door in open position.

FIG. 4 shows the cassette of FIG. 3 with the door completely closed.

FIG. 5 shows a horizontal section through the sliding door cassette as indicated in FIG. 4. This section shows the long walls 2 and 3 of the cassette, which may be manufactured from 1 mm thick galvanized steel plate. Along the vertical edges of the opening 8 there is arranged sealing brushes 12 which will seal against the door 11 in its closed position. Along the vertical edges of the opening 9 there is arranged a soft felt 13 in order to facilitate a soft and frictionless movement of the door 11. The arrow 14 suggests the direction of movement of the door when it is opened.

FIG. 5 also shows that the sliding door cassette is built into a wall structure 15, where plates 16 are inserted in turned-in edges 17 of the openings 8, 9.

FIG. 6 shows a section along the line VI-VI in FIG. 4. Again, the sealing brush 12 and the felt 13 are seen. Additionally, a sill 18 in the bottom 7 of the cassette is shown. The top of the sill 18 is flush with the adjacent floor 19, in order to permit unhindered movement of wheelchairs through the door opening. A U-formed groove 20 in the sill provides guiding for a suitable guiding means 21 attached to the lower edge of the door. The lower edge is also provided with a sealing brush 22. At the top the door is provided with a caster support 23, which runs in a rail which is firmly fixed in the top wall 6 of the cassette.

FIG. 7 is a section along the line VII-VII in FIG. 4, i.e. through the door opening 10. This section shows a sealing brush 25 being arranged along the upper edge of the opening 8. The sealing brush 12 along the longitudinal edges and the sealing brush 22 on the underside of the door together will form a continuous sound-proofing along the entire circumference of the door.

FIG. 8 shows a section similar to FIG. 5, with the difference that the cassette of steel plate is replaced by a cassette of ordinary building materials, i.e. building plates 26, e.g. fiber plates such as MDF-plates, or plywood, and a framework 27 of woodwork. Thus, the cassette may form a finished wall portion to be integrated into the adjacent walls.

FIG. 9 shows a section similar to FIG. 6 through the cassette, and FIG. 8. The rail 24 for suspending the sliding door is attached to a top piece 28 of woodwork corresponding to the top wall 6 of the cassette.

FIG. 10 is a section similar to FIG. 7 of the embodiment according to FIGS. 8 and 9, with the difference that the rail 24 is attached in an inverted U-formed reinforcement, e.g. of steel plate material, in order to provide a stiffened support for the rail 24. This is of importance in order to secure that the finally adjusted, straight extent of the rail from the factory is not disturbed when the cassette is mounted in the wall structure.

It will be understood that the invention is not limited to the exemplifying embodiments shown in the drawings, but that it may be modified and varied by the skilled person within the frame of the following patent claims.

1. A sliding door arrangement comprising a sliding door (1) which is movably suspended in a rail system (23, 24) in order to be moved horizontally between two outer positions wherein it respectively opens and closes a door opening (10), characterized in that the sliding door (11) is mounted in a cassette (1) arranged for insertion in a wall (15) of a building.

2. A sliding door arrangement according to claim 1, wherein the cassette comprises two vertical long walls (2, 3), two vertical short walls (4, 5), one top wall (6) and one bottom wall (7), wherein the long walls (2, 3) have openings (8, 9) which form a door opening (10).

3. A sliding door arrangement according to claim 2, wherein the rail system comprises a rail (24) which is supported in the top wall (7) of the cassette (1), and casters (23) which run in the rail (24) and in which the sliding door (11) is suspended.

4. A sliding door arrangement according to claim 2, 3 or 4, wherein the cassette (1), along vertical edges and the upper edge of at least one of the openings (8, 9), is provided with sealing means (12, 25) which seal against the sliding door in the closed position thereof.

5. A sliding door arrangement according to any one of claims 2-5, wherein the sliding door (11) on its bottom side is provided with sealing means (22) which seal against the bottom wall (7) of the cassette (1).

6. A sliding door arrangement according to claim 4 or 5, wherein said sealing means comprise one or more of sealing brushes, felt, felt with elastic extending fibers, or plush seals.

7. A sliding door arrangement according to any one of claims 2-6, wherein the sliding door (11) on its bottom side is provided with guiding means (21) which cooperate with a U-formed groove (20) in the bottom wall (7) of the cassette (1).

8. A sliding door arrangement according to anyone of claims 2-7, comprising a threshold (18), the top side of which is arranged to be flush with an adjacent floor (19) when the cassette is built into the building.

9. A sliding door arrangement according to any one of claims 2-8, wherein the cassette (1) is made substantially of metal plate material, at least some edges of the openings (8, 9) being in-turned to form grooves that can receive parts of the wall structure (15).

10. A sliding door arrangement according to any one of claims 2-8, wherein the cassette is made substantially of building materials (26, 27) in order to be mounted as a substantially finished wall portion in a wall (15) in the building, an upper part of the cassette preferably having a reinforcement (29) of metal plate to which said rail system (24) is attached.
